(19) United States
(12) Patent Application Publication
(10) Pub. No.: US 2011/0271488 A1
(43) Pub. Date: Nov. 10, 2011

(54) Extendable Universal Holding Device

(76) Inventors: Robert Todd Swinderman, Palm Coast, FL (US); Carl James Reinertsen, Palm Coast, FL (US)

(21) Appl. No.: 12/614,404

(22) Filed: Nov. 7, 2009

(51) Int. Cl. B25G 1/04

(52) U.S. Cl. 16/421

(57) ABSTRACT

A handle system with a universal gripping end is disclosed which comprises a handle at one end, intermediate sections for adjustable length and angle and a universal gripping end designed to accommodate a wide variety of common grooming aids and tools. The system is designed to collapse into a compact size for storage. It can also be extended and locked in any number of advantageous positions so that it can be adapted to a wide variety of common applications that are difficult for persons with disabilities to perform or where safely extending the reach of a tool is advantageous.

### CROSS-REFERENCE TO RELATED APPLICATIONS

Not Applicable

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates to an extendable and adjustable holder that can be adapted to hold any number of common grooming aids and tools to permit an individual to extend their range of reach.

2. General Background

Many people have limited range of motion in their hands and arms making common tasks such as grooming difficult if not impossible to do with standard grooming aids. Grooming activities such as brushing one's hair is a typical task that is difficult for people with conditions that restrict their range of arm motion. Therefore, daily grooming becomes something that can only be done with the help of a second person. There are many other common tasks such as using a hand mirror or washing that are difficult for such individuals to accomplish.

Additionally there are many common maintenance and repair tasks that could be aided or done more safely by increasing the reach of the worker such as cleaning or painting. Overreaching when working from a ladder is a common cause of accidents.

There are a number of devices such as that disclosed in U.S. Pat. No. 6,189,222 B1 that are designed for a specific purpose or to work only with a specially designed attachment. Another example of an extendable and adjustable handle designed for a specific use is the Swifter Duster line of products as disclosed in U.S. Pat. No. 6,813,801 as a specialized dust pad designed to be used only with the Swifter extensible handle. It is a disadvantage for the individual to procure, store and use multiple devices and attachments for common activities. There are other gripping devices that depend upon the continuous application of force by the user to maintain a grip on the object to be grasped. The present invention overcomes these disadvantages by allowing a wide variety of common grooming aids and tools to be easily mounted on a single universal handle with a simple retaining method that can be applied by people with restrictive conditions such as arthritis.

### SUMMARY OF THE INVENTION

One object of the present invention is to provide an extendable lockable handle with a universal gripping holder that allows the user to use multiple grooming aids in a wide variety of positions.

It is another object of the invention to provide an extendable lockable handle with a universal gripping holder that can fold into a compact arrangement suitable for storage and transport.

It is another object of the invention to provide an extendable lockable handle with a universal gripping holder that allows the user to attach various common household cleaning and maintenance tools.

It is another object of the invention to increase the reach of the user by providing an articulated handle with a universal gripping holder that can be adjusted and locked in various advantageous positions.

Further features and advantages of the present invention, as well as the operation of the invention, are described in detail below with reference to the accompanying drawings.

### BRIEF DESCRIPTION OF THE DRAWINGS

FIG. 1 is a view of the assembly extended in a z-shaped configuration.

FIG. 2 is a view of the assembly collapsed for storage.

FIG. 3 is a view of the assembly holding a paintbrush in a fully extended position.

FIG. 4 is a view of the assembly holding a squeegee in a Z-shaped configuration with the squeegee articulated at 90 degrees.

FIG. 5 is a view of the assembly holding a hairbrush having a stylistic and odd shaped handle.

FIG. 6 is an exploded view of the preferred embodiment.

FIG. 7 shows an alternative embodiment of the extendable handle.

### DETAILED DESCRIPTION OF THE PREFERRED EMBODIMENT

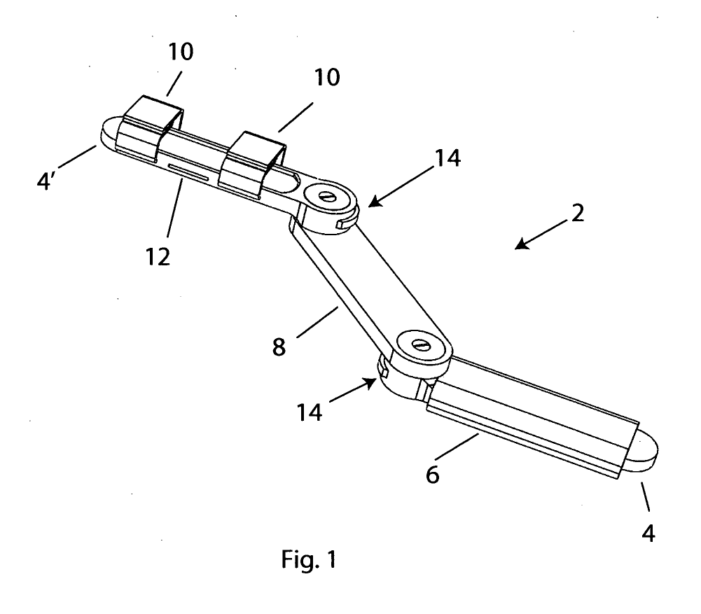

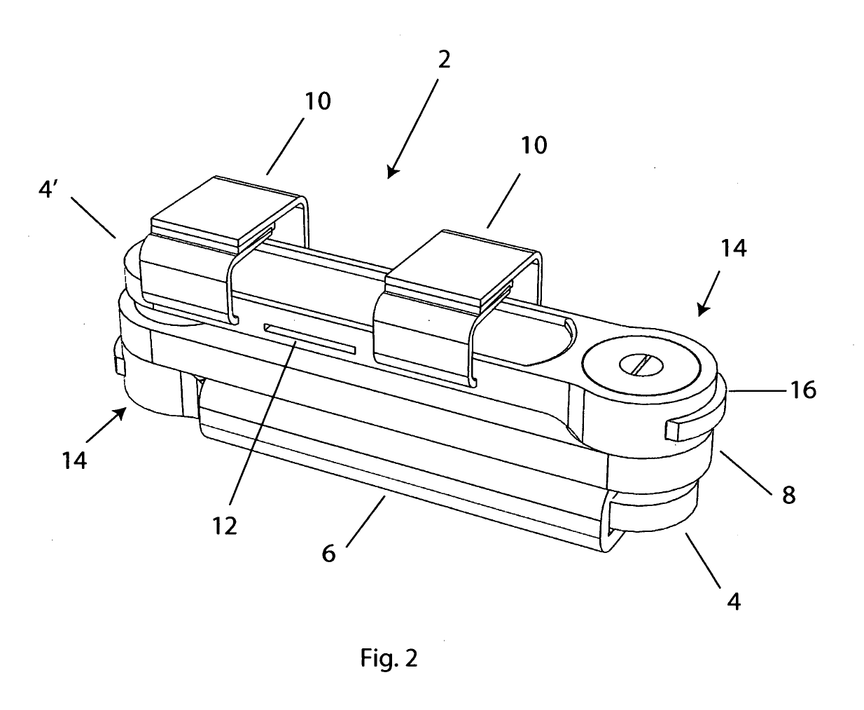

FIG. 1 shows the universal extendable holding device assembly 2 in an extended Z-shaped configuration which consists of a combination handle & holder 10, grip 6, center section 8, elastic hook and loop fasteners 10 and ratchet mechanism 14. The handle 4 & holder 4′ is adapted for use as a handle by inserting the handle 4 into grip 6. The holder 4′ is adapted for use as a holder by inserting elastic hook and loop fasteners through slots 12. In the preferred embodiment handle 4 and holder are identical and grip 6 will fit on handle 4, holder 4′ and center section 8. Provisions are made for three slots 12 which can accommodate up to three elastic hook and loop fasteners 10. Ratchet mechanism 14 selectively locks the assembly in the desired angular position.

FIG. 2 shows the assembly 2 collapsed for storage. The assembly is collapsed by depressing pawl 16 which allows handle 4 and holder 4′ to rotate freely to the collapsed position. When pawl 16 is released the handle 4 or holder 4′ is selectively prevented from rotation by the ratchet mechanism 14.

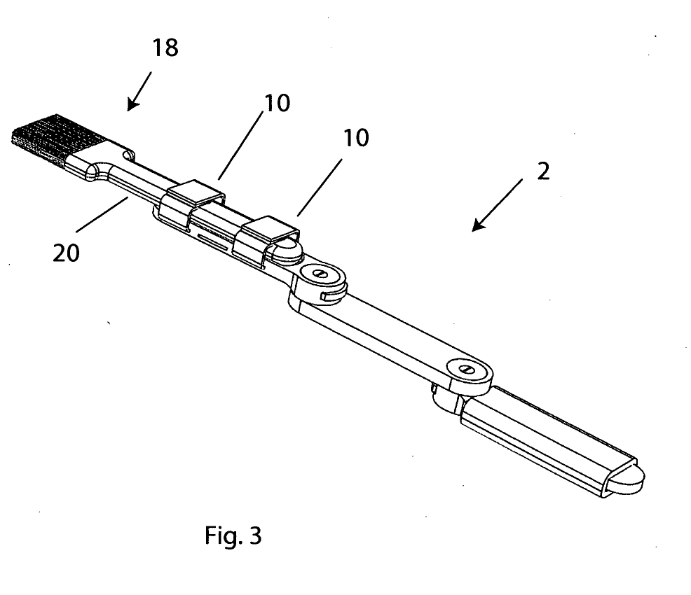

FIG. 3 shows the assembly 2 holding a paintbrush 18. Typically paintbrush handles 20 have a generally oval shape. Paint brush 18 is held in the holder by disengaging the elastic hook and loop fastener 10, placing paintbrush handle 20 on the holder 4′ and stretching the ends of the elastic hook and loop fastener 10 over the paintbrush handle 20 and while stretched, engaging the hook and loops to retain the paintbrush handle 20 under the compression of the elastic hook and loop fasteners 10.

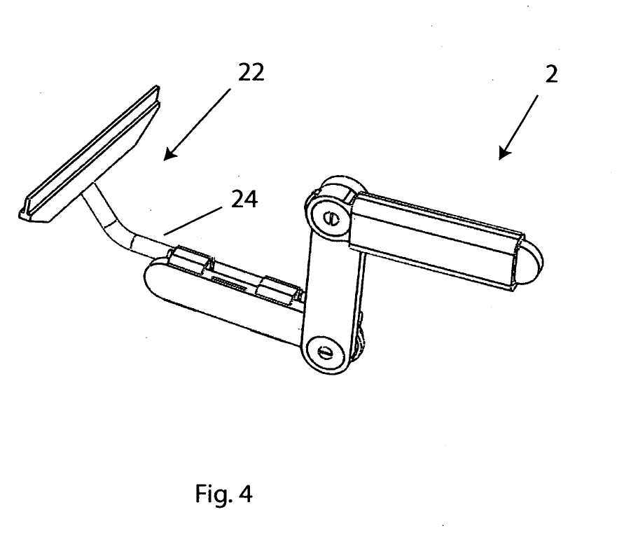

FIG. 4 shows the assembly 2 holding a squeegee 22. Typically squeegee handles 22 have a generally round shape. Squeegee 22 is held in the holder by disengaging the elastic hook and loop fastener 10, placing squeegee handle 24 on the holder 4′ and stretching the ends of the elastic hook and loop fastener 10 over the squeegee handle 24 and while stretched, engaging the hook and loops to retain the squeegee handle 24 under the compression of the elastic hook and loop fasteners 10.

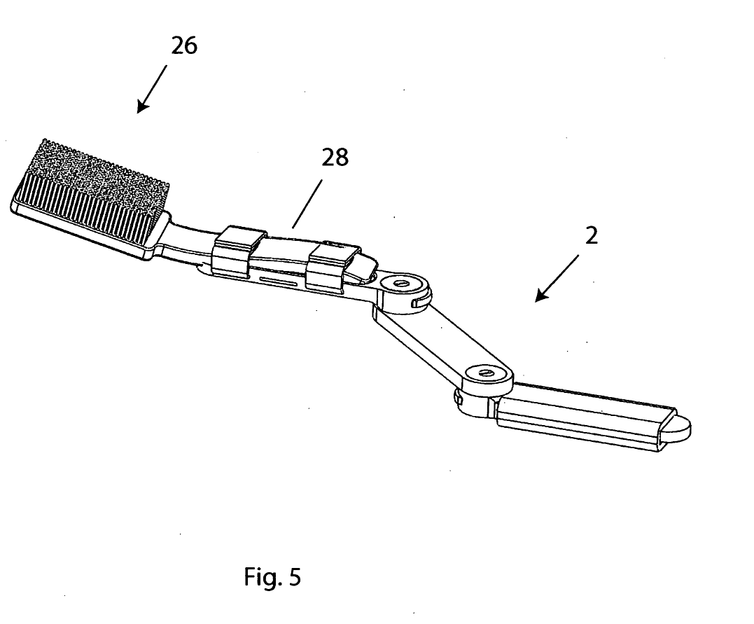

FIG. 5 shows the assembly 2 holding a hairbrush 26. Typically hairbrush handles 20 have a curved stylistic shape. Hairbrush 26 is held in the holder by disengaging the elastic hook and loop fastener 10, placing hairbrush handle 28 on the holder 4′ and stretching the ends of the elastic hook and loop fastener 10 over the hairbrush handle 28 and while stretched, engaging the hook and loops to retain the hairbrush handle 28 under the compression of the elastic hook and loop fasteners 10.

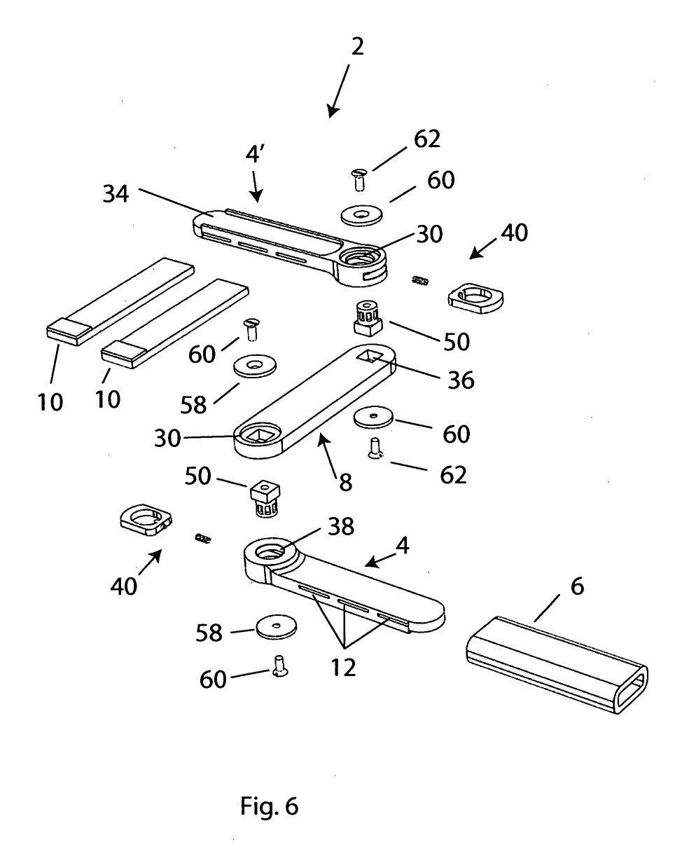

FIG. 6 is an exploded view of assembly 2. Handle 4 and holder 4′ is a molded plastic part typically made from glass filled ABS plastic. Handle 4 and holder 4′ includes recess 34 which forms a pocket for retaining handles such as 20, 24 and 28. Slots 12 pass through the body of the handle 4 and holder 4′ and form a cavity for retaining elastic hoop and loop fasteners 10. Elastic hook and loop fasteners 10 are of the type sold under the trade name VELSTRETCH® by Velcro Industries B.V. Handle 4 and holder 4′ contains recesses 30 which is adapted to accept washers 60. Handle 4 and holder 4′ contains recesses 32 which are configured to accept pawl assemblies 40 with a sliding fit. Ratchet 50 is preferable made from steel and end 54 is configured to fit into bore 30 with a sliding fit in handle 4 and holder 4′. Threaded bore 56 extends through ratchet 50. Center section 8 is a molded plastic part typically made from glass filled ABS plastic. Ratchet 50 end 52 is generally square and configured to press fit into cavity 36 in center section 8. Assembly is accomplished by inserting pawls 40 into cavities 32 and ratchets 50 into cavities 36 in each end of center section 8 and then while depressing pawl 40 placing handle 4 and holder 4′ over ratchets 50. Fasteners 62 are then inserted in threaded bores 56 of ratchets 50 to complete the assembly.

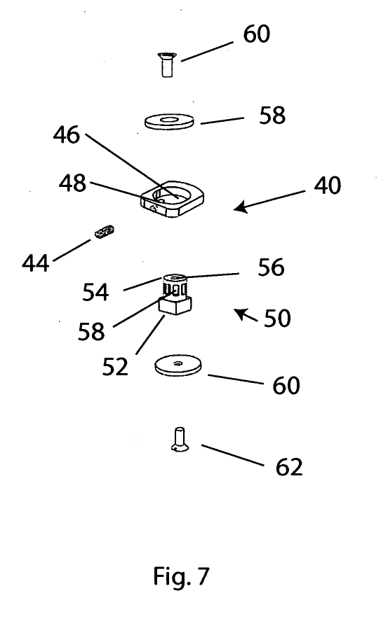

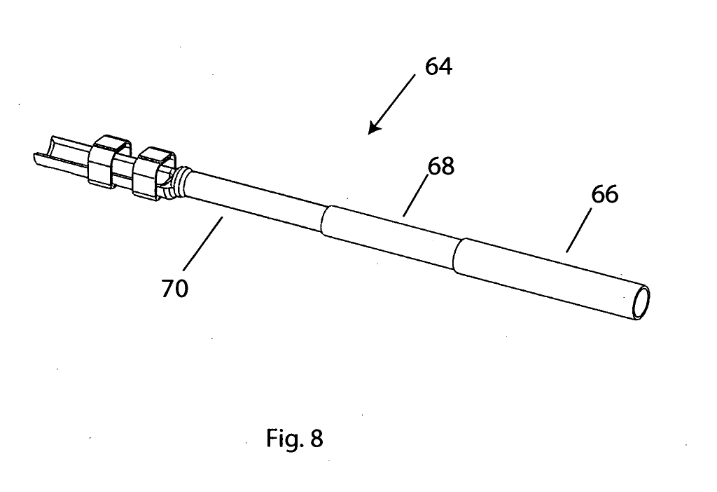

FIG. 7 is an exploded view of pawl 40 and ratchet 50. Pawl 40 consists of pawl 42 preferably made from steel and spring 44 mad from spring steel. Pawl 40 includes elongated cavity 46, which allows the pawl to restrictively move in cavity 32 when ratchet 50 is in place. Spring 44 provides the force to keep tooth 48 engaged in slots 58 of ratchet 50. Tooth 48 is disengaged from slots by pressing pawl 42 and compressing spring 44. When the compression is released tooth 48 will engage a slot 58 when the angular positions align. Pawl 42 includes tooth 48 designed to engage slots 58 in ratchet 50. Slots 58 are equally spaced around diameter 54 to provide selective locking positions for handle 4 and holders 4′ in relation to center section 8. In the preferred embodiment there are eight slots 58. The length of ratchet 50 is such that when washers 58 and fasteners 60 are fully engaged, handle 4 and holders 4′ and center section 8 are in contact with each other in a slightly compressive manner. The compressive interface allows frictional rotation of the handle 4 and holders 4′ relative to the center section 8.

For example, FIG. 8 is an example of an alternate embodiment 64 of the invention with a telescoping handle 66, center section 68 and holder 70. The telescoping embodiment 64 can be locked into position by any number of standard methods used for telescoping handles such as detents or cams.

It will be apparent to one skilled in the art that while a preferred embodiment of the invention has been shown and described, various alternative arrangements, modifications and material substitutions can be made but the invention will still perform the desired function. Additionally, various sizes of the invention may be of practical use from a small configuration suitable for personal grooming which can be stored in a purse to a large industrial version suitable for maintenance and repairs. It should be noted that for safety, the assembly is constructed primarily of glass filled ABS plastic, which will not conduct electricity. It should be further noted that the lightweight but strong construction of glass filled ABS plastic is an advantage.

What is claimed is:

1. A selectively extendable handle and holder comprising a handle at one end adapted for grasping by hand, a holder at the opposite end comprising at least one elastic hoop and loop fastener adaptable to retaining any common grooming aid or tool and; the handle and holder being selectively lockable in relation to each other.

2. The selectively extendable handle and holder of claim 1 comprised of at least One handle, one center section and one holder.
